(19) United States
(12) Patent Application Publication
(10) Pub. No.: US 2010/0041391 A1
(43) Pub. Date: Feb. 18, 2010

(54) EMBEDDED MOBILE ANALYTICS IN A MOBILE DEVICE

(76) Inventors: Anthony Wayne Spivey, Holly Springs, NC (US); Blane E. Rockafellow, Raleigh, NC (US); Frank Andrew Smoak, Cary, NC (US); Keith Collins, Durham, NC (US)

Correspondence Address: ROBERT PLATT BELL;REGISTERED PATENT ATTORNEY, P.O. BOX 13165, Jekyll Island, GA, 31527, US

(21) Appl. No.: 12/393,576

(22) Filed: Feb. 26, 2009

Related U.S. Application Data
(60) Provisional application No. 61/088,026, filed on Aug. 12, 2008.

(51) Int. Cl. H04W 24/00

(52) U.S. Cl. 455/425

(57) ABSTRACT

A method or process enables the collection of data from mobile devices and mobile networks using filtering, compression, encryption, memory management, and power management technologies to collect mobile device metrics at the mobile device (client side), and then transmit these metrics from the mobile device to a server for processing by analytics software. The analytics processing may also occur directly on the mobile device. Policies are determined and configured at the processing server to drive and control the mobile device metrics captured, which may include but are not limited to, data usage (e.g. time of day, amount of data sent/received), voice usage (e.g. time of day, calls in/out of network, dropped calls, call duration), the location of the mobile device, cell patterns (e.g. problem cells, roaming), touch interactions, behavioral analysis (programs used, services uses), battery performance, CPU usage, memory usage, network usage (e.g. 2G, 3G, 3.5G, 4G, Wi-Fi, WiMAX), and the like.

### CROSS-REFERENCE TO RELATED APPLICATIONS

The present application claims priority from Provisional U.S. Patent Application No. 61/088,026 filed on Aug. 12, 2008, and incorporated herein by reference.

### FIELD OF THE INVENTION

The present invention relates to embedded mobile analytics in a mobile device, such as a cellular telephone or the like. In particular, the present invention is directed toward a method and process for enabling the collection, storage, and transmittal of data on a mobile device to be utilized in the analysis of mobile device usage, range, and other criteria. The method of the present invention uses policy provisioning, filtering, compression, encryption, memory management, and power management technologies to collect mobile analytics at the mobile device (client side), and then transmit these metrics from the mobile device to a server for processing by analytics software, or perform and display analytics processing of these metrics directly on the mobile device.

### BACKGROUND OF THE INVENTION

Collecting data on the operation, range, and use of mobile devices is presently difficult at best. To determine whether cellular telephone service is adequate in many areas, many cellular providers rely upon consumer complaints, as well as manual testing of such systems. As in traditional commercial radio testing, mobile trucks or the like, equipped with antennas and the like, will drive to different areas and measure relative signal strength of cellular signals and then use this data to manually generate maps of coverage areas. From this test data, gaps in coverage may be determined and thus planning for additional cell towers or capacity may be generated.

The problems with this technique are many. It requires an expensive mobile truck or equipment be used, along with expensive trained personnel, who are largely unsupervised, to produce such data. Given the limited nature of budgets and the limited amount of data one collection van can obtain in a given day, the amount of coverage data produced can be fairly paltry compared to the overall coverage areas of any given cellular system. In addition, using specialized receiving equipment in a truck does not provide an accurate reflection of actual cell service. While measurements of signal strength and the like are useful, they do not necessarily equate with actual call quality, number of dropped calls, and the like, but rather provide only theoretical calculated values as to service quality.

Consumer complaints about service are highly unreliable, as it can be difficult to pinpoint where service is being dropped or signal strength is low, as consumers may be unreliable reporters of such data. In addition, some consumers may complain more than others, and as a result, the reporting of poor reception areas may be biased or uneven.

Primitive attempts have been made to automate some of this type of data collection. By placing actual cellular phones in strategic locations, it is possible to monitor such phones to determine whether cellular coverage exists (e.g., whether a tower is operating). A dedicated cellular telephone is placed in a building or other location, and can be called periodically to determine whether a signal is present. This technique has its drawbacks as well. In order to provide any amount of coverage, a large number of mobile devices would need to be used to cover different areas. In addition, such a system tells little else than the signal is working—but does not provide any information as to signal strength and other criteria. Since the mobile devices are fixed, the actual boundaries of coverage are limited, and thus little useful data is obtainable.

Another alternative is to send out agents into the field equipped with actual mobile devices to test the quality and boundaries of coverage within a given system. However, such a technique would be costly to implement, due to the large number of people required, as well as manpower to monitor such calls. One popular advertising campaign for a cellular telephone company posits such a technique for testing cell systems (e.g., “Can you hear me now?®”) however, this is more of an advertising slogan than a real demonstration of a practical system to testing cell service coverage.

One problem with all such Prior Art techniques is that they do not take into account actual system usage. Cellular telephone service is based largely on a “threshold of pain” technique to provide adequate service at a reasonable price. While it is technically feasible to provide high signal strength nationwide by adding more and more cells, towers, antennas and equipment to the network, the cost of such additional hardware would be prohibitive, driving up the cost of service beyond what consumers are prepared to pay.

Consumers are prepared to deal with a certain “threshold of pain” with regard to cellular service in exchange for lower monthly service costs. Thus, consumers expect that service in some rural areas may be spotty or intermittent, and may be prepared for the occasional dropped call or poor signal strength. On the other hand, consumers expect to find high signal strength and regular service in urban areas. Cellular carriers need to allocate resources effectively to provide sufficient service in areas of high usage, while allocating less resources to areas where customers are not as active.

Prior art signal strength measurement techniques do not take this “threshold of pain” concept in to account. In rural areas, signal strength may be low, however, customer expectations of service may also be low. Moreover, the number of customers using the system in such areas may be limited. Thus, it makes no sense to allocate system resources based on signal strength alone. Rather, a balanced decision must be made based on the most effective deployment of limited resources to provide the best possible service for a given price of service.

It would be useful in the art, therefore, to provide a method of determining the scope, extent, and quality of mobile device service without having to manually collect such data. Such data would be useful not only to mobile device companies in determining where and when to devote resources (installation of additional cell towers and the like). In addition, mobile device manufacturers could utilize such data to improve mobile device design.

### SUMMARY OF THE INVENTION

A need exists in the art to collect metrics at mobile devices and then transmit these metrics back to a server for analytics processing, or perform and display analytics directly on the mobile device. Types of metric information recorded, but not limited to, may include data and events that describe the characteristics of the mobile device or the characteristics of the mobile network that the mobile device is operating within. As an example, the change in signal strength over time can be recorded at the mobile device and then analyzed (i.e., either fed back to the analytics server for processing or processed at the device) to assist in determining the level of network coverage. Another example is capturing metrics around dropped calls and/or active users within specific cell tower ranges to provide the information necessary to analyze network coverage and loading.

A method or process for enabling the collection and transmittal of data utilized in the analytics of mobile device metrics. This method uses filtering, compression, encryption, memory management, and power management technologies to collect mobile device metrics at the mobile device (client side), and then transmit these metrics from the mobile device to a server for processing by analytics software, or to perform and display the analytics processing at the mobile device. Policies are determined and configured at the server, at the mobile device, or a combination of the two, to drive and control the mobile device metrics captured, which may include but are not limited to, data usage (e.g. time of day, amount of data sent/received), voice usage (e.g. time of day, calls in/out of network, dropped calls, call duration), the location of the mobile device, cell patterns (e.g. problem cells, roaming), touch interactions, behavioral analysis (programs used, services uses), battery performance, CPU usage, memory usage, network usage (e.g. 2G, 3G, 3.5G), and the like. The provisioning policies determine what type of probing is to be performed, when it is to be performed, and when the data is to be reported from the mobile device to the analytics server. The provisioning rules may also be used to determine the circumstances under which the probing should be halted, suspended, or resumed.

Note that the term “mobile device” as used in the present invention may apply to any mobile device, including but not limited to cellular telephones, personal assistants, computers or processing devices equipped with cellular or other communications links, and the like. Mobile devices are continually expanding in terms of the number of applications, and devices such as the iPhone, are combining multiple features of computing, music, mapping, GPS, messaging, and traditional cellular phone operation. It is envisioned that such devices will continue to expand in terms in complexity and number of features, combining what traditionally in the past were discrete components. The present invention may be applied to all types of such mobile devices, without departing from the spirit and scope of the present invention.

The present invention may be used by cellular telephone providers, who may use such data to monitor system usage and determine not only where areas of spotty or weak coverage occur, but the amount of system usage in such areas. Thus, if there are a large number of dropped calls in a particular area, further resources may be diverted to improve signal strength in that area. On the other hand, if an area experiences dropped calls, but system usage is low in that area, assets may not be allocated to that area based on this data. In addition, the system of the present invention may utilize mobile device data to filter out spurious data. For example, if a call is dropped because the phone battery level is low, then that data may be filtered out, as it may not represent a real lack of coverage for the area, but rather a consumer error.

Cell phone manufacturers may also utilize such data to determine which features and functions of phone are most useful to consumers and which can be dropped. As the number of features on a mobile device proliferates, consumers are subject to “feature fatigue” as they become confused by the large number of features, usually accessible only through layers of menus and the like. This “feature fatigue” is one reason simplified cell phone devices (e.g., Jitterbug®) are popular with some demographics (e.g., the elderly) that do not want or need additional features such as custom ring tones, text messaging, GPS, music, or other features. Cell phone manufacturers can use data on the actual use of such features and make informed decisions on which features to add or drop to new product lines.

Data regarding the use of such features (or lack thereof) in a given area can also be useful in marketing service plans to consumers and in marketing products. If text messaging is not popular in certain areas (e.g., retirement community) then it may be worthwhile to market more basic products and plans to such areas. On the other hand, in areas where consumers use text messing more often (e.g., suburban area) it may be worthwhile to emphasize such plans and devices. Given that most consumers spend the majority of their time within a 25-mile radius of their homes, the use of certain mobile device features in a given area is a relative indication of the popularity of such features with residents in such areas. Actual use of such features in a given area may be useful in marketing such features and plans.

In addition, marketing of features and services can be individually targeted toward consumers based on actual use. If a given consumer uses many of the advanced features on a phone, that consumer may be targeted for marketing materials for advanced mobile devices with advanced features and/or service plans offering such features. Marketing of mobile devices and service plans can be narrowly targeted to desired audiences, limiting the number of consumers distracted or annoyed by marketing that clearly is not aimed toward their needs.

These and other features of the present invention will be described in more detail below in connection with the accompanying Figures.

### BRIEF DESCRIPTION OF THE DRAWINGS

FIG. 1 is a functional block diagram illustrating the overall architecture of the system of the present invention.

FIG. 2 is a system diagram. Similar elements in both Figures are given similar reference numerals.

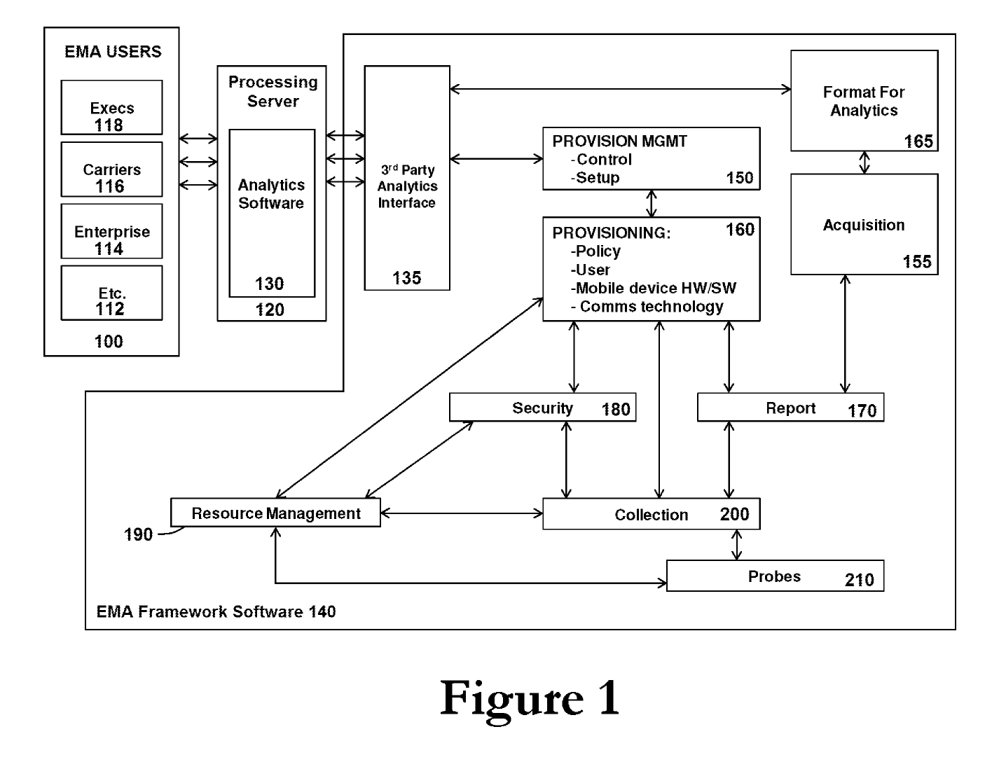

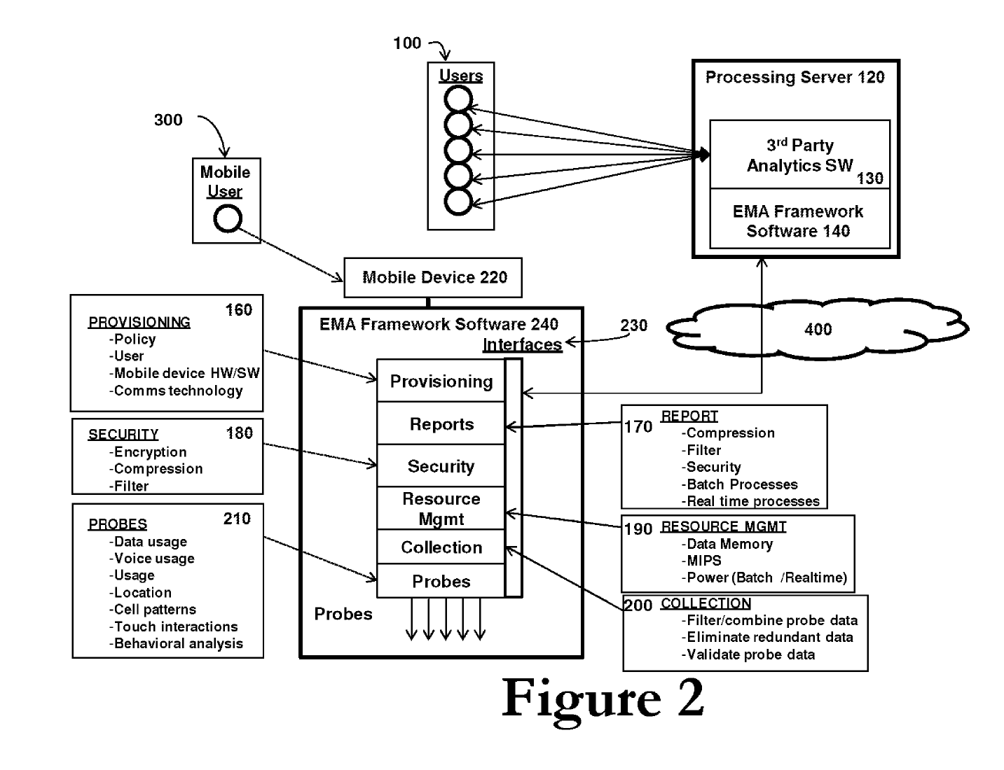

The present invention will be described in connection with the above Figures, in which similar elements are given similar reference numerals (e.g., EMA Framework Software is present in both figures, in FIG. 1 as element 140 and FIG. 2 as element 240).

### DETAILED DESCRIPTION OF THE INVENTION

FIG. 1 is a functional block diagram illustrating the basic functional data flow of the Embedded Mobile Analytics (EMA) system of the present invention. Referring to FIG. 1, EMA users 100 in the present invention, may comprise executives, 118, cellular carriers 116, enterprises 114, or other users 112, interested in obtaining information about cellular telephone usage and analytics, as described above. Analytics companies may operate analytics software 130, to provide EMA users 100 with information on cellular telephone usage and business information. Analytics companies may include a processing server 120 that may contain one or more third-party analytics software programs 130. Note that analytics software 130 may be configured to provide only statistical data on usage, and not individual user's information, in order to comply with privacy laws and concerns. Optionally, data may be encrypted or otherwise secured such that only legally authorized persons have access to individual usage data. The EMA Framework Software 140 comprises the core of the present invention and represents the entire invention and is instantiated in two forms, running on either the processing server 120 or the mobile device (FIG. 2, 240).

Third party analytics interface 135 provides the interface between the analytics software 130 and the invention. This third party interface 135 may include a provision management setup 150, which allows for control and setup of the provisioning portion 160. Provisioning portion 160 defines policies, users, mobile device hardware and software, and communications technology.

Processing server 120 may include both a customer's third-party analytics software 130 and EMA Framework software 140, which may control policies 160, security 180, capabilities and flow control of reported data 170. Mobile devices may be provisioned and controlled by EMA Framework software 140 (e.g., from the network operator's location) to collect 200, report 170, and securely transmit 180 mobile device information back to analytics software 130 on processing server 120 of analytics companies. This provisioning and controlling 160, collection 200, security 180 and transmission 170 may be accomplished without action from third-party analytics software 130. While it is possible that the raw mobile device information collected by probes 210 may be manually viewed 170 at a mobile device, the management of data 190 on a mobile device should be such that the processing for analysis of the raw data and events is performed by third-party analytics software 130 and/or EMA Framework software 140 on processing server 120 or on a mobile device itself.

Note that collected mobile device data from a mobile device may be transmitted to analytics software 130 in such a manner that the data is not visible to the mobile device user, and/or the mobile device user is not aware of the data being collected and transmitted. Such data may be made anonymously, such that individual user data is not reported to mobile device users 100. Alternately, such data may be securely encrypted and other security measures taken to ensure that consumer data is only available to authorized agencies (e.g., law enforcement and the like).

In the event user 100 or mobile user desires to display 170 some of the processed mobile device data on a mobile device, processed data may then be sent back to a display mechanism on the mobile device from software on processing server 120. In this manner, analytics data may be downloaded to a mobile device in the field to check on local data, track other cell phones, monitor other cell phone usage, or the like. Such applications may be useful for law enforcement agencies and the like. Traditionally, law enforcement agencies, to track cell phone calls, needed to purchase expensive monitoring equipment. Since most law enforcement agencies have limited budgets, purchase of such equipment may not be possible. The present invention allows for data monitored from another cell phone (number called, duration of call, location of phone, or the like) to be downloaded to another phone for monitoring purposes. Note, however, that display of this data on the mobile device is not necessary to the operation of the present invention.

Note also that such data may be downloaded to another user's phone for purposes other than law enforcement. For example, employers may utilize such data to monitor employee locations, track and locate employees, monitor employee cell phone usage, and the like. This data can be downloaded to an employer's mobile device, or transmitted to the employer via Internet or the like. Similarly, such data may be used by parents to track, monitor, and locate children, monitor children's cell phone usage and the like, and control cell phone usage (e.g., limiting text messaging and calling during school hours or other time periods).

In addition, the system of the present invention may be used by parents to monitor vehicle usage. By monitoring speed (as determined by GPS, multilateration, or other techniques), a parent can determine whether a child has been speeding with the family car or the like. In addition, by tracking speed and location, mobile device features (e.g., text messaging or the like) can be disabled by a parent or the like when the phone in use is indicated to be traveling above a certain velocity. The number of uses for the data gathered by the present invention is nearly limitless.

In the present invention, a mobile device may be provisioned 150/160 to probe for different types of mobile device data useful to the type of analysis being performed. This probing may require download to the phone of a software module, or this probing feature may be incorporated into the phone as software or firmware. For example, a network operator may be interested in mobile device data to include data usage (e.g. time of day, amount of data sent/received), voice usage (e.g. time of day, calls in/out of network, dropped calls, call duration), location of the mobile device, cell patterns (e.g. problem cells, roaming), touch interactions, behavioral analysis (programs used, services uses), battery performance, CPU usage, memory usage, network usage (e.g. 2G, 3G, 3.5G, 4G, Wi-Fi, WiMAX, etc.), and the like.

This information may be used in a number of ways for business purposes. For example, cellular telephone companies may utilize such information to better assess where new cell towers or antennas should be located, based on system usage, dropped calls and the like. In addition, where and when to locate data services and other systems may also be determined by usage. There is little point in rolling out a new data service in an area where users are not using such services, just as there is little point in locating a new cell tower in an area rarely used by customers.

Cellular telephone designers may also use such data to determine how the devices are functioning in the field—whether battery life is sufficient, what services users use the most and least, and the like. There is little point in adding additional services and features to a phone if they are not utilized by the consumer. For example, there is little point in extending battery life, if consumers find the existing batteries are sufficient. On the other hand, if data shows many consumers running low on battery power, then a new, more powerful battery may be needed. Utilizing traditional customer survey techniques to determine customer demands and concerns are often costly and inaccurate, as the sample sizes of such surveys are often too small, and the persons answering such surveys skew the resultant data, as only those with an active interest in technology may answer such surveys. The present invention, in contrast, provides data to cellular telephone designers and other interested parties based on actual use of equipment, and thus the data can be collected inexpensively and accurately.

Note that the present invention may be applied to other uses as well. For example, by determining the number of active mobile devices in a particular area (e.g., by GPS location), the system may determine or estimate crowd sizes at events more accurately than traditional hand- counting or estimating. Such data can also be collected in real-time, assisting police, emergency services, and other first responders in handling crowd control and the like. Such data may also be used to track behavior patterns of people visiting various sites and areas in order to provide better urban planning and the like. While such data may be obtained by measuring the number of signals from a particular cell tower, that data does not provide as precise location data as a GPS signal locating individual phones. The number of uses for the data produced by the present invention is by no means limited by the examples set forth herein. The present invention provides a means for harvesting and analyzing such data. The actual use of such data may have many uses.

Provisioning rules 150/160 may determine what type of collection and probing 200/210 is to be performed, when it is to be performed, and when data is to be reported 170 from mobile device to third-party analytics software 130. Provisioning rules 160 may also be used to determine the circumstances under which probing 210 should be halted, suspended, or resumed.

The EMA Framework Software 140 connects a processing server 120 (e.g., a PC, a web-based server, or enterprise server) to one or more mobile devices for secure communication 170 of mobile device data collected 200 on mobile devices (e.g., mobile user, network, location) for analysis by third-party analytics software 130 and/or EMA Framework software 140 This process also allows for the analytics report 170 to occur on a mobile device. This process provides the ability to apply policy decisions based on the capabilities 160 of a mobile device to collect 200, upload and report 170 data and events. Security features 180 (described below) in this process keep information private 180 or anonymous and policies 160 set the parameters regarding what should be collected 200/210 and who is allowed to see 170 the collected information. The policy may be coordinated between EMA Framework software 140 and mobile device provisioning 160, as well as between EMA Framework software 140 and third-party analytics software 130 and users 100 of collected and manipulated mobile device data 170.

Mobile device users would likely object to any perception that their whereabouts or actions are being tracked by software without their permission. Thus, individual identifying data (mobile device owner, name, address, and the like) may be eliminated from the data stream and the resulting data made anonymous. For purposes of the present invention, such data may not be necessary to statistical analysis of mobile device usage and other purposes. In other words, it is not necessary to understand exactly who is using their phone when and where, but only that a phone was used in that manner, and that anonymous data added to the stream. In this manner, actions of individuals may not be tracked and logged, but only actions of mobile devices (which may be assigned pseudo-anonymous names or numbers for this purpose). Alternately, such user data may be tracked, but kept in a secure fashion using security 180, which encrypts the data such that the data is not readily accessible except to law enforcement agencies or the like, with court order, or by permission of the user.

Security aspects 180 of this process include parameters regarding where and when to apply encryption to the data to be transferred 170 to/from the mobile device from/to EMA Framework software 140 and/or third-party analytics software 130. Data encryption 180 may be applied to data on a mobile device before data is transferred 170 to EMA Framework software 140 as well as encryption 180 of the data stream itself. Data stored 190 on a mobile device may be encrypted 180 to prevent a mobile user from corrupting or otherwise modifying data 190, and to ensure that data copied 190 from a mobile device to an unauthorized analytics device is surrounded by security 180.

Security 180, as defined for this invention includes compression. Compression 180 aspects of this process also include parameters 160 regarding where and when to apply compression 180 to data to be transferred 170 to/from a mobile device from/to the third-party analytics software 130 and/or the EMA Framework software 140. Compression 180 may also be coupled to encryption mechanism 180 to allow for a smaller, more secure data transfer and thus reduce interference with the consumer's use of the device and also preserve bandwidth. Compression 180 may be important in order to minimize storage required on the mobile device and to make the most efficient use of network connectivity. Balancing of encrypting 180 and compressing 180 of data is important and EMA Framework software 140 contains utilities 190, which efficiently and effectively manage this balance. Some choices may be made based on input regarding storage priority vs. the priority of security. For example, if encrypted data is larger than unencrypted data, a design decision may be relative to the priority of security versus memory.

Authentication, part of EMA Framework software 140, of third-party analytics software 130 to a mobile device may include a mechanism to allow for the acknowledgement and handshake 150/160 between mobile devices and processing server 120 to ensure only authorized devices are receiving the communications. This process may also work without authentication, but the authentication allows for added security. It may be important to have authentication of server 120 to mobile devices so that a mobile device knows it is talking to an authorized server 120 and not some rogue server.

The present invention allows for a mobile device to initiate actions 170/200 to configure reporting 170 of collected data 200 and control parameters 200 back to processing server 120. While this process generally results in a request from EMA Framework software 140 and a response 170 from a mobile device, the process optionally allows for a mobile device to initiate action 160/170/200 (after setup) based on event occurrence 160 without requests from processing server 120. Based upon policies 160, a mobile device may determine the best times to initiate communications 170 with EMA Framework Software 140. These policies 160 may include but are not limited to availability of a broadband connection, passing a certain threshold of storage, user inactivity, battery level, and the like to automate this process.

FIG. 2 is a system block diagram of the EMA system of the present invention, and illustrates the techniques for collection of mobile device data on mobile device 220, and the secure transmittal of this data 170 back to a third-party analytics software 130 residing on a processing server 120, as well as the processing of this data at mobile device 220.

In FIG. 2, the processing server 120 is shown including both a customer's third-party analytics software 130 and EMA Framework software 140 which may control 160 the policies, security, capabilities and flow control of reported data 170. Processing server 120 may also contain one or more third-party analytics software programs 130. The EMA Framework Software 240 represents another instantiation of the invention's software. EMA Framework Software 240 functionality on mobile device 220 may also be used to process or display metrics data created by EMA Framework software 240 on mobile device 220.

Mobile devices 220 may be provisioned and controlled by EMA Framework software 140 (e.g., from the network operator's location) to collect 200, filter 180, report 170, and securely transmit 180 mobile device information back to EMA Framework software 140 on processing server 120. This provisioning and controlling 160, collection 200, filtering 180, reporting and transmission 170 may be accomplished without action from third-party analytics software 130. While it is possible that the raw mobile device information 210 may be manually viewed 170 at mobile device 220, the management of data 190 on mobile device 220 should be such that the processing for analysis of the raw data and events is performed by third-party analytics software 130 and/or EMA Framework software 140 on processing server 120 or on mobile device itself 220.

In the event user 100 or mobile user 300 desires to display 170 some of the processed mobile device data on the mobile device 220, processed data may then be sent back to a display mechanism on mobile device 220 from software on processing server 120 or EMA Framework software 240 of mobile device 220. Note, however, that display of this data on mobile device 220 is not necessary to the operation of the present invention.

In the present invention, mobile device 220 may be provisioned 160 to probe for different types of mobile device data useful to the type of analysis being performed. For example, a network operator may be interested in mobile device data to include data usage 210 (e.g. time of day, amount of data sent/received), voice usage 210 (e.g. time of day, calls in/out of network, dropped calls, call duration), the location of the mobile device 210, cell patterns 210 (e.g. problem cells, roaming), touch interactions 210, behavioral analysis 210 (programs used, services uses), battery performance 210, CPU usage 210, memory usage 210, network usage 210 (e.g. 2G, 3G, 3.5G, 4G, Wi-Fi, WiMAX, etc.), and the like. Provisioning rules 140/160 may determine what type of probing 200/210 is to be performed, when it is to be performed 200/210, and when data is to be reported 170 from mobile device 220 to third-party analytics software 130. Provisioning rules 160 may also be used to determine the circumstances under which probing 210 should be halted, suspended, or resumed.

As part of EMA Framework process 240, mobile device 220 may be loaded with software containing a set of APIs 230 (i.e., interfaces that control each of the event types to be monitored) which may be accessed by other software components 180/190/200 in mobile device 220 to collect 200 the information without mobile user 300 noticing interference with the normal operation of mobile device 220. These APIs and events may be public or private. In some cases there may need to be new functionality 170/200/210 added to the device to perform the operations required of the APIs. Event monitoring and API invocation may be tuned according the target device and operating system.

This process connects a processing server 120 (e.g., a PC, a web-based server, or enterprise server) to one or more mobile devices 220 for secure communication 170 of mobile device data collected 200 on mobile devices 220 (e.g., mobile user, network, location) for analysis by third-party analytics software 130 and/or EMA Framework software 140. This process also allows for the analytics 170 to occur on mobile device 220. This process provides the ability to apply policy decisions based on the capabilities 160 of mobile device 220 to collection 200, uploading and reporting 170 of data and events. Security features 180 (described below) in this process keep information private 180 and policies 160 set the parameters regarding what should be collected 200/210 and who is allowed to see 170 the collected information. The policy may be coordinated between EMA Framework software 140 and mobile device provisioning 160, as well as between EMA Framework software 140 and third-party analytics software 130 and users 100 of collected and manipulated mobile device data 170.

Security aspects 180 of this process include parameters regarding where and when to apply encryption to the data to be transferred 170 to/from mobile device 220 from/to EMA Framework software 140 and/or third-party analytics software 130. Data encryption 180 may be applied to data on mobile device 220 before data is transferred 170 to EMA Framework software 140 as well as encryption 180 of the data stream itself. Data stored 190 on mobile device 220 may be encrypted 180 to prevent a mobile user 300 from corrupting or otherwise modifying data 190, and to ensure that data copied 190 from mobile device 220 to an unauthorized analytics device is surrounded by security 170.

Compression 180 aspects of this process also include parameters 160 regarding where and when to apply compression 180 to data to be transferred 170 to/from mobile device 220 from/to the third-party analytics software 130 and/or the EMA Framework software 140. Compression 180/190 may also be coupled to encryption mechanism 180 to allow for a smaller, more secure data transfer. Compression 180/190 may be important in order to minimize storage required on mobile device 220 and to make the most efficient use of the network connection 400. Balancing of encrypting 180 and compressing 180 of data is important and EMA Framework software 240 contains utilities 190, which efficiently and effectively manage this balance. Some choices may be made based on input regarding storage priority vs. the priority of security. For example, how does the size of storing encrypted data compare to the size of storing unencrypted data? If encrypted data is larger than unencrypted data, a design decision may be relative to the priority of security versus memory.

Authentication, part of EMA Framework software 140, of third-party analytics software 130 to mobile device 220 may include a mechanism to allow for the acknowledgement and handshake 160 between mobile devices 220 and processing server 120 to ensure only authorized devices are receiving the communications. This process may also work without authentication 160, but the authentication allows for added security. It may be important to have authentication of processing server 120 to mobile devices so that mobile device 220 knows it is talking to an authorized server 120 and not some rogue server.

The present invention allows for mobile device 220 to initiate actions 170/200 to configure reporting 170 of collected data 200 and control parameters 200 back to processing server 120. While this process generally results in a request from EMA Framework software 140 and a response 170 from mobile device 220, the process optionally allows for mobile device 220 to initiate action 160/170/200 (after setup) based on event occurrence 160 without requests from processing server 120. Based upon policies 160, mobile device 220 may determine the best times to initiate communications 170 with EMA Framework Software 140. These policies 160 may include but are not limited to availability of a broadband connection, passing a certain threshold of storage, user inactivity, battery level, and the like to automate this process.

The present invention may also contain algorithms to manage resources 190 of mobile device 220 to allow for lower power usage 190, compressed data files for enhanced memory utilization 190, and low usage of CPU cycles 190.

The present invention manages collection 200 of data and events coming from either a primary mobile device 220 for which collection 210 is taking place, or devices and users connected to a primary mobile device 220 (e.g., through technologies like EV-DO, CDMA, EDGE, GSM, UMTS, BT, Wi-Fi, WiMAX, etc.).

While the preferred embodiment and various alternative embodiments of the invention have been disclosed and described in detail herein, it may be apparent to those skilled in the art that various changes in form and detail may be made therein without departing from the spirit and scope thereof.

We claim:

1. A method for enabling collection and transmittal of mobile device metrics, the mobile device metrics including one or more of, battery level, dropped calls, signal strength, numbers dialed, calls received, features used, text messages sent, and voice calls made, mobile device location, said method comprising the steps of:
generating mobile device metrics data in a probe in the mobile device;
filtering the mobile device metrics to eliminate spurious or duplicate metrics data;
encrypting the mobile device metrics data to prevent unauthorized users from reading the mobile device metrics data;
compressing the mobile device metrics data to reduce bandwidth needed to transmit the mobile device metrics data;
transmitting the mobile device data metrics from the mobile device to a server;
processing the mobile device metrics data in the server, using analytics software to analyze mobile device metrics data.

2. The method of claim 1, further comprising the steps of:
encrypting the mobile device metrics data, after said step of filtering the mobile device metrics, to prevent unauthorized users from reading the mobile device metrics data.

3. The method of claim 1, further comprising the steps of:
compressing the mobile device metrics data, after said step of filtering the mobile device metrics, to reduce bandwidth needed to transmit the mobile device metrics data.

4. The method of claim 1, wherein the step of processing the mobile device metrics data comprises the step of analyzing frequency of dropped calls and low signal strength and mobile device location to map low signal strength areas.

5. The method of claim 1, wherein said step of filtering comprises the step of filtering out dropped calls from the mobile device metrics data, where the dropped calls occur during low battery power conditions.

6. The method of claim 1, wherein the step of processing the mobile device metrics data comprises the step of analyzing mobile device usage to determine frequency of usage of mobile device features.

7. The method of claim 1, wherein the step of processing the mobile device metrics data comprises the step of analyzing location of mobile devices during mobile one or more of device voice calls and text messages to determine areas of frequent usage of mobile devices.

8. The method of claim 1, wherein the step of processing the mobile device metrics data comprises the step of analyzing mobile device battery levels to determine average battery level usage for mobile devices.

9. The method of claim 1, wherein the step of processing the mobile device metrics data comprises the step of analyzing features used on the mobile device.

10. The method of claim 1, wherein the step of generating mobile device metrics data in a probe in the mobile device; comprises the steps of downloading to the mobile device, a software module for probing the mobile device, and operating the software module to probe the mobile device.

11. The method of claim 1, wherein the step of generating mobile device metrics data in a probe in the mobile device; comprises the steps of installing in the mobile device, a hardware probe for probing the mobile device, and operating the hardware probe to probe the mobile device.

12. The method of claim 1, wherein the mobile device metrics comprise one or more of:
data usage, including one or more of time of day, amount of data sent and received;
voice usage, including time of day, calls in/out of network, dropped calls, and call duration;
location of the mobile device;
cell patterns, including problem cells and roaming;
touch interactions;
behavioral analysis, including programs used and services uses;
battery performance;
CPU usage;
memory usage; and
network usage, including 2G, 3G, 3.5G, 4G, Wi-Fi, and WiMAX.

13. The method of claim 1, further comprising the step of provisioning policies determining what type of probing is to be performed, when it is to be performed, and when the data is to be reported from the mobile device to the analytics server.

14. The method of claim 11 wherein the provisioning policies determine circumstances under which the probing is one or more of halted, suspended, and resumed.
